(19) United States
(12) Patent Application Publication
(10) Pub. No.: US 2026/0259801 A1
(43) Pub. Date: Sep. 3, 2026

(54) STORAGE SYSTEM AND STORAGE CONTROL METHOD

(71) Applicant: Hitachi Vantara, Ltd., Yokohama-shi (JP)

(72) Inventors: Akira DEGUCHI, Tokyo (JP); Masahiro ARAI, Tokyo (JP)

(73) Assignee: Hitachi Vantara, Ltd., Yokohama-shi (JP)

(21) Appl. No.: 19/323,305

(22) Filed: Sep. 9, 2025

(30) Foreign Application Priority Data
Feb. 28, 2025 (JP) 2025-032370

(51) Int. Cl. G06F 11/14

(52) U.S. Cl. CPC G06F 11/1451; G06F 11/1464; G06F 11/1469

(57) ABSTRACT

A storage system backs up data of a volume as snapshots of a plurality of generations. The storage system may back up the snapshots as difference data, which is a difference from snapshots of other generations. When a restore instruction of data is received, the storage system restores a snapshot of one generation, applies difference data from the snapshot to the restored snapshot to restore a snapshot of another generation, repeats restoring a snapshot of another generation by applying another difference data to a snapshot restored by applying the difference data, and restores snapshots of a plurality of generations.

### BACKGROUND OF THE INVENTION

### 1. Field of the Invention

The present invention generally relates to storage control, such as data recovery.

### 2. Description of Related Art

A damage caused by ransomware is increasing. Due to ransomware infection, the stored data is encrypted. Not only ransomware but also some kind of malware infection causes a damage such as encryption or tampering of the stored data, and normal data becomes damaged data. PTL 1 discloses a technique for recovering data using a snapshot.

### CITATION LIST

### Patent Literature

PTL 1: JP2015-153298A

### SUMMARY OF THE INVENTION

Since data may be damaged by ransomware, the data is generally backed up. The recovery of the backed up data includes repetition of the following (S1) to (S3).

(S1) Select data to be recovered.

(S2) Restore the data selected in (S1).

(S3) When there is a damage caused by ransomware in the restored data, the processing returns to (S1).

A restore time, which is a time required for restoration in (S2), is one of the elements that occupy a relatively large recovery time, which is a time required for data recovery. An increase in restoration speed contributes to shortening the recovery time.

The shortening of the data recovery time is not limited to the data recovery in the case of being infected with malware such as ransomware or receiving so-called cyberattack, and is also desirable in other cases.

A storage system backs up data of a volume as snapshots of a plurality of generations. The storage system can back up a snapshot as difference data, which is a difference from a snapshot of another generation. When a restore instruction of data is received, the storage system can restore a snapshot of one generation, and apply difference data between the restored snapshot and a snapshot of another generation to the restored snapshot to restore a snapshot of another generation. In addition, the snapshots of a plurality of generations are restored by repeatedly restoring a snapshot of another generation by applying another difference data to a snapshot restored by applying the difference data.

The data recovery time can be shortened.

### BRIEF DESCRIPTION OF THE DRAWINGS

FIG. 1 shows a configuration of a storage system according to an embodiment.

FIG. 2 shows a configuration of a part of a data center.

FIG. 3 shows a configuration of a memory in a backup source storage.

FIG. 4 shows a configuration of the memory in a backup server.

FIG. 5A shows an example of data management in the backup source storage.

FIG. 5B shows an example of data management in the backup source storage.

FIG. 6 shows an example of snapshot management in the backup source storage.

FIG. 7 shows a configuration of a mapping table.

FIG. 8 shows a flow of backup processing.

FIG. 9A shows a configuration of a catalog.

FIG. 9B shows a configuration of backup information.

FIG. 9C shows a configuration of difference information.

FIG. 9D shows backup data comprising a data unit as difference data.

FIG. 10 schematically shows an outline of an example of recovery processing.

FIG. 11 shows a configuration of a restored snapshot management table.

FIG. 12 shows a flow of processing executed by a first restore program.

FIG. 13 shows a flow of processing executed by a scanning program.

FIG. 14 shows a flow of processing executed by a second restore program.

FIG. 15 shows a configuration of a storage system according to a first modification.

FIG. 16 shows a configuration of a cloud storage according to a first modification.

FIG. 17 shows a configuration of a part of a storage system according to a second modification.

FIG. 18A shows a configuration of a server according to the second modification.

FIG. 18B shows a configuration of a VM-VOL table according to the second modification.

FIG. 18C shows an example of states of snapshots and a VM storage area according to the second modification.

FIG. 19 shows a flow of backup processing according to the second modification.

### DESCRIPTION OF EMBODIMENTS

In the following description, an “interface device” may be one or more communication interface devices. The one or more communication interface devices may be one or more communication interface devices of the same type (for example, one or more network interface cards (NICs)) or two or more communication interface devices of different types (for example, NIC and host bus adapter (HBA)).

In the following description, a “memory” is one or more memory devices serving as an example of one or more storage devices, and may typically be a main storage device. At least one memory device in the memory may be a volatile memory device or a non-volatile memory device.

In the following description, a “persistent storage device” may be one or more persistent storage devices, which are examples of one or more storage devices. The persistent storage device may be typically a non-volatile storage device (for example, an auxiliary storage device), and specifically, for example, a hard disk drive (HDD), a solid state drive (SSD), a non-volatile memory express (NVME) drive, or a storage class memory (SCM).

In the following description, a “processor” may be one or more processor devices. The at least one processor device may be typically a microprocessor device such as a central processing unit (CPU), and may be another type of processor device such as a graphics processing unit (GPU). The at least one processor device may be a single core or a multi-core. At least one processor device may be a processor core. At least one processor device may be a broadly defined processor device such as a circuit (for example, a field-programmable gate array (FPGA), a complex programmable logic device (CPLD), or an application specific integrated circuit (ASIC)) that is a collection of gate arrays in a hardware description language for performing a part or all the processing.

In the following description, information that can be output in response to an input may be described by an expression such as “xxx table” or “xxx list”, whereas the information may be data of any structure (for example, may be structured data or unstructured data), and may be a learning model such as a neural network, a genetic algorithm, or a random forest that generates an output in response to an input. Therefore, the “xxx table” or “xxx list” can be referred to as “xxx information”. In the following description, a configuration of each table is an example. One table may be divided into two or more tables, or all or a part of two or more tables may be one table.

In the following description, processing may be described using a “program” as a subject, but since a program is executed by a processor to perform determined processing using a storage device and/or an interface device as appropriate, the subject of the processing may be a processor (or a device or a system including the processor). The program may be installed on a device such as a computer from a program source. The program source may be, for example, a program distribution server or a computer-readable recording medium (for example, a non-transitory recording medium). In addition, in the following description, two or more programs may be implemented as one program, or one program may be implemented as two or more programs.

A “volume” (VOL) is a logical storage area. The volume may be a substantive volume (RVOL) or a virtual volume (VVOL). The “RVOL” may be a VOL based on a storage device, and the “VVOL” may be a volume according to a capacity virtualization technique (typically, Thin Provisioning).

Any information (for example, at least one of “name” and “number”) may be adopted as information (ID) for identifying an element.

In addition, in the following description, when elements of the same type are described without being distinguished, a common reference numeral may be used, and when elements of the same type are distinguished and described, reference numerals may be used.

Next, embodiments will be described.

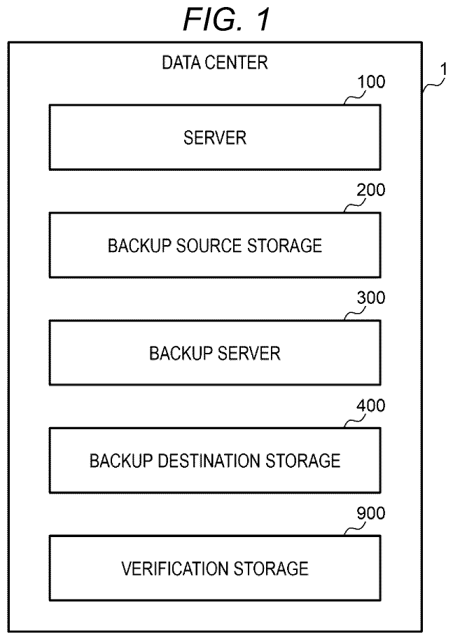

FIG. 1 shows a configuration of a storage system according to an embodiment.

A data center 1 is constructed as a storage system. The data center 1 includes a server 100, a backup source storage 200 (a backup source storage device), a backup server 300, a backup destination storage 400 (a backup destination storage device), and a verification storage 900 (a storage device used for verification). Each of these elements 100, 200, 300, 400, and 900 may be a physical device or a logical device (for example, a device as a cloud computing service on a cloud platform). The server 100 may be included in the backup source storage 200. The backup server 300 may be included in the storage 200, 400, or 900. Further, at least a part of the storages 200, 400, and 900 may be a physical or logical storage device, and specifically, for example, each of one or more physical computers may execute predetermined software to construct the one or more physical computers as software-defined anything (SDx). For example, software-defined storage (SDS) or software-defined datacenter (SDDC) can be adopted as SDx.

The server 100 performs business processing. For example, the server 100 executes a program (software) such as middleware or an application to issue an I/O request for I/O (input/output) of data to a volume provided by the backup source storage 200. The server 100 may be referred to as a host.

The backup source storage 200 provides a volume, receives an issued I/O request, and performs I/O to the volume in accordance with the I/O request. That is, the backup source storage 200 stores data used for business processing performed by the server 100.

The backup server 300 backs up and restores data. In the backup, data is read from the backup source storage 200, and the read data is transferred to the backup destination storage 400. In the restoration, data is transferred from the backup destination storage 400 to the verification storage 900. In the verification storage 900, the data is further reverted. In the present embodiment, data is reproduced by a combination of restoration (data transfer between storages) and revert (data transfer in a storage). The data recovery includes data reproduction and scanning (infection presence/absence check) of the reproduced data. The data recovered in the verification storage 900 is transferred to the backup source storage 200, and the server 100 can perform business processing using the data recovered in the backup source storage 200. The function of the verification storage 900 may be provided in the backup source storage 200. That is, the verification storage 900 may function as the backup source storage 200 and the verification storage 900. A recovery destination of the data may be any storage device instead of the verification storage 900 or the backup source storage 200.

The backup destination storage 400 is a storage device that is a backup destination of data stored in the backup source storage 200. Typically, the backup destination storage 400 is a storage device different from the backup source storage 200, and may be the same device as the backup source storage 200. The backup destination storage 400 may be a storage device that is less expensive than the backup source storage 200 to store backup data (data to be backed up), for example, any of an object storage, a file storage, and a block storage. In general, the object storage or the file storage is less expensive than the block storage. Therefore, when the backup destination storage 400 is an object storage or a file storage, the backup source storage 200 may be a block storage.

In a case where an abnormality may occur in data in the backup source storage 200, specifically, in a case where the backup source storage 200 is infected with malware such as ransomware or the backup source storage 200 is subjected to a so-called cyberattack, the verification storage 900 recovers and scans (checks) the backup data to find normal data (for example, data that is not damaged by infection or cyberattack).

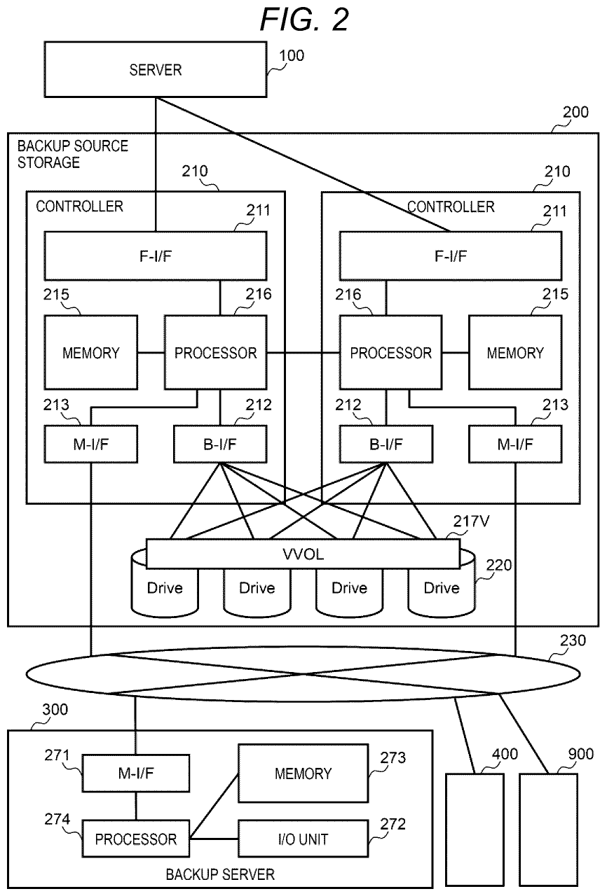

FIG. 2 shows a configuration of a part of the data center 1.

The backup source storage 200 includes a drive group (a plurality of drives 220) and redundant controllers 210 that perform I/O of data to the drive group. Each of the drives 220 is an example of a persistent storage device. The drive group may constitute one or more redundant arrays of independent (or inexpensive) disks (RAID) groups. A virtual volume (VVOL) 217V as an example of a volume is provided based on the drive group.

Each of the controllers 210 includes a front-end interface (F-IF) 211, a back-end interface (B-IF) 212, a management interface (M-IF) 213, a memory 215, and a processor 216 connected thereto. The IFs 211, 212 and 213 are examples of an interface device.

The F-IF 211 is an interface device that communicates with the server 100. The F-IF 211 may have a plurality of ports (for example, Fibre Channel ports, iSCSI ports). The B-IF 214 is an interface device that communicates with each drive 220. The M-IF 215 is an interface device that communicates with the backup server 300.

The memory 215 stores programs and data. The memory 215 may include, for example, a cache memory area for temporarily storing data. The processor 216 executes a program stored in the memory 215.

The backup server 300 may be a computer including an M-IF 271, an I/O unit 272, a memory 273, and a processor 274 connected thereto. The M-IF 271 is an interface device having a port connected to a network 230. The I/O unit 272 may be a user interface device such as a keyboard, a pointing device, or a display device. The I/O unit 272 may not be provided, and a function of the I/O unit 272 may be implemented by a client computer (not shown) connected to the backup server 300 via the network 230. The memory 273 stores programs and data. The processor 274 performs backup and restoration by executing a program. The same interface device may serve as both the F-IF 211 and the M-IF 215.

The network 230 may be any network such as the Internet or a wide area network (WAN). The server 100 and the backup source storage 200 may also be connected via the network 230 or may be connected via another network. In addition to the backup source storage 200 and the backup server 300, the backup destination storage 400 and the verification storage 900 may be connected to the network 230. The configurations of the storages 200, 400, and 900 may be the same or different.

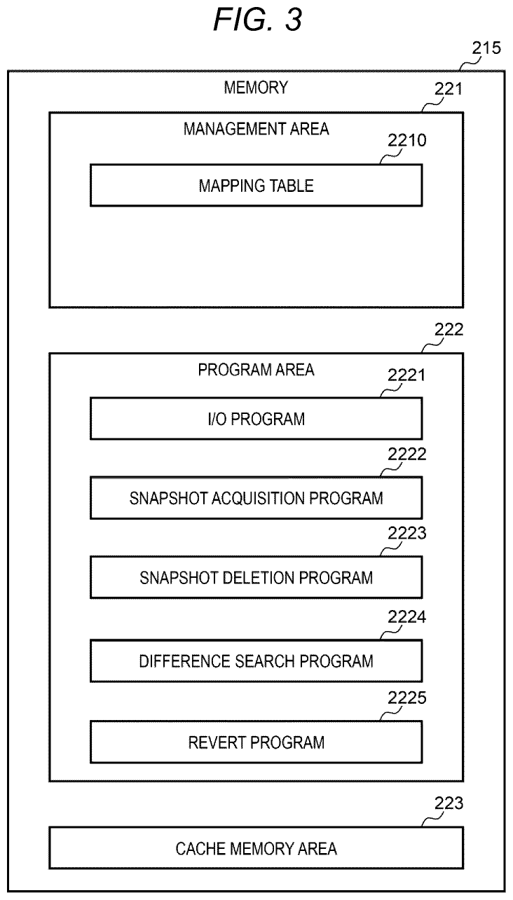

FIG. 3 shows a configuration of the memory 215 in the backup source storage 200.

The memory 2159 includes a management area 221, a program area 222, and a cache memory area 223.

Management information is stored in the management area 221. The management information includes a mapping table 2210. Details of the mapping table 2210 will be described later.

The program area 222 stores programs. The stored programs include an I/O program 2221, a snapshot acquisition program 2222, a snapshot deletion program 2223, a difference search program 2224, and a revert program 2225. The I/O program 2221 performs I/O of data to a volume in response to an I/O request in backup, restoration, or the like. The snapshot acquisition program 2222 acquires a snapshot. The snapshot deletion program 2223 deletes a snapshot. The difference search program 2224 performs a difference search using the mapping table 2210. The revert program 2225 performs reverting. Details of these programs 2221 to 2225 will be described later.

Data (typically, data input to and output from the drive 220) is temporarily stored in the cache memory area 223.

Although not shown, a configuration of a memory in the verification storage 900 may be the same as the configuration of the memory 215 shown in FIG. 3. The backup source storage 200 may not include the revert program 2225.

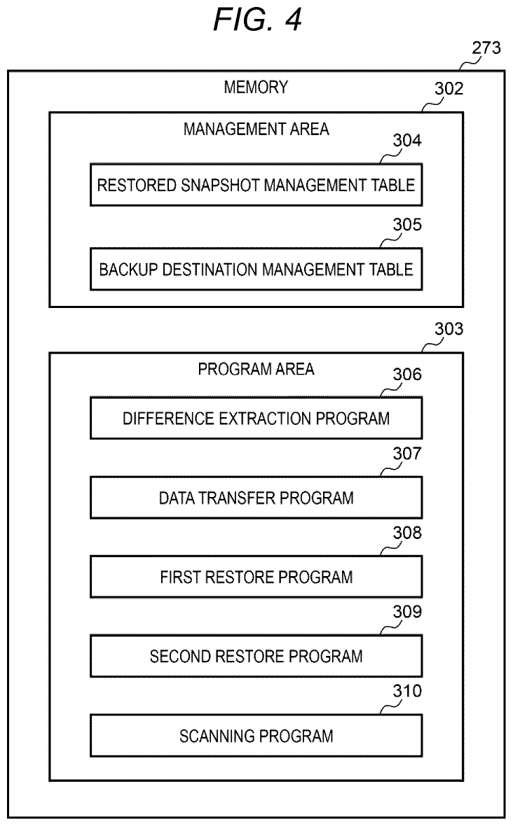

FIG. 4 shows a configuration of the memory 273 in the backup server 300.

The memory 273 includes a management area 302 and a program area 303.

Management information is stored in the management area 221. The management information includes a restored snapshot management table 304 and a backup destination management table 305. Details of the restored snapshot management table 304 will be described later. The backup destination management table 305 includes a storage number (an example of identification information) and a backup destination area (for example, bucket information) of the backup destination storage 400.

The program area 303 stores programs. The stored programs include a difference extraction program 306, a data transfer program 307, a first restore program 308, a second restore program 309, and a scanning program 310. The difference extraction program 306 extracts a difference in the backup processing. The data transfer program 307 transfers data in the backup processing. Each of the first restore program 308 and the second restore program 309 causes the verification storage 900 (and/or another storage device) to restore data. The scanning program 310 causes the verification storage 900 (and/or another storage device) to scan data, or scans data. Details of these programs 306 to 310 will be described later.

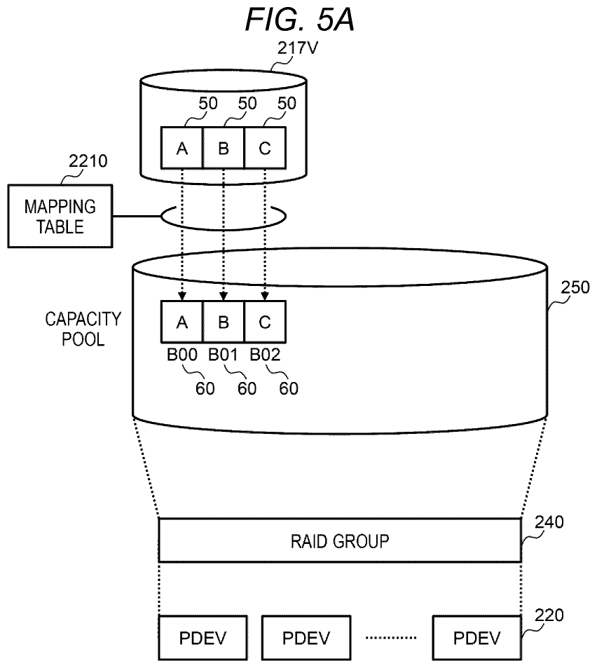

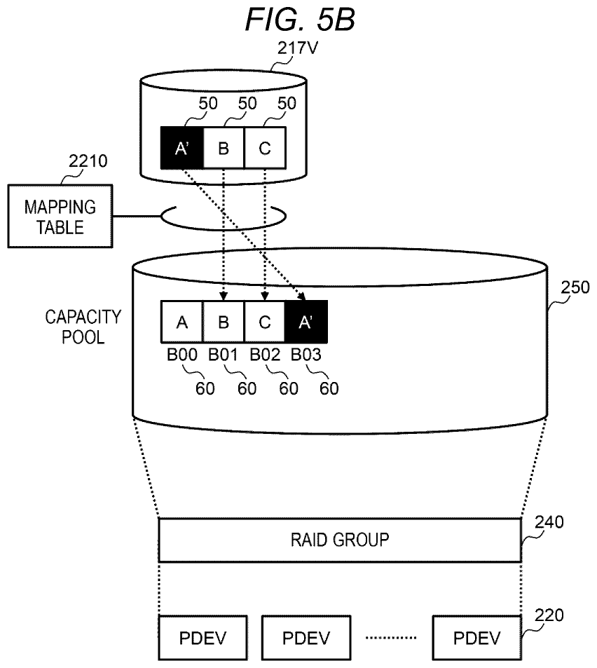

FIGS. 5A and 5B show an example of data management in the backup source storage 200.

There is a capacity pool 250 as a storage space based on a RAID group 240 composed of a drive group. The VVOL 217V is a storage space provided to the server 100. When data is written into the VVOL 217V, a real area 60 in the capacity pool 250 is allocated to a virtual area 50 of a write destination in the VVOL 217. That is, so-called thin provisioning is applied. Each of the areas 50 and 60 may be referred to as a block, a page, or a segment. A specific example of the data management is as follows. Data occupying each of the areas 50 and 60 may be referred to as a “data unit” for convenience.

According to the example shown in FIG. 5A, three data units “A”, “B”, and “C” are stored in three virtual areas 50 in the VVOL 217. In this example, as indicated by dotted arrows in FIG. 5A, three real areas (their addresses are B00, B01, and B02) in the capacity pool 250 are allocated to three virtual areas 50, and the three data units are written to the three virtual areas 50. A correspondence relation between the addresses of the three virtual areas 50 and the addresses of the three real areas 60 is recorded in the mapping table 2210.

Here, as shown in FIG. 5B, when the I/O program 2221 of the backup source storage 200 receives a write request of the updated data unit “A'” to the virtual area 50 in which a data unit “A” is written from the server 100, the I/O program 2221 secures a new real area 60 (for example, an address B03) in the capacity pool 250 and writes a data unit “A'” to the secured real area 60. Next, in the mapping table 2210, the I/O program 2221 associates the address B03 of the newly secured real area 60 instead of the original virtual area (B00) with an address of the virtual area 50 in which the data unit “A'” is written. Since the original real area 60 (B00) is not referred to by any of the virtual areas 50, the original real area 60 (B00) is determined to be an unused real area 60, and is collected at an appropriate timing (managed as a free real area 60), and thus the original real area 60 can be associated with any of the virtual areas 50.

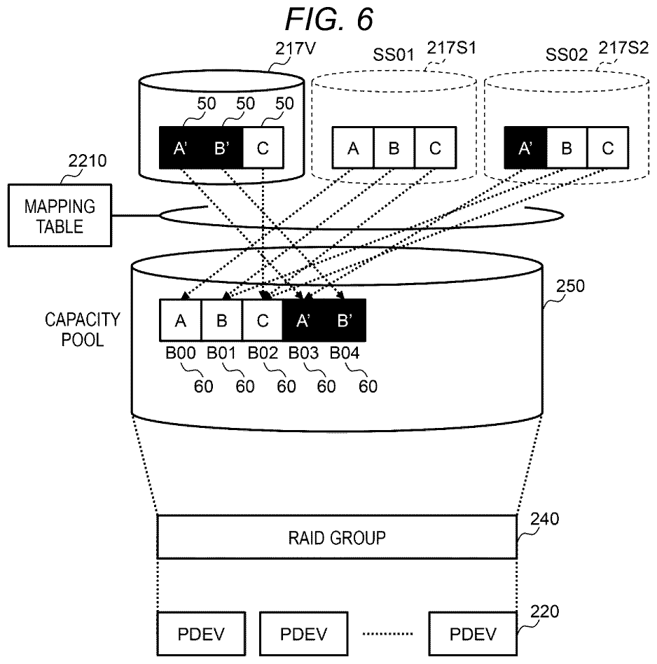

FIG. 6 shows an example of snapshot management in the backup source storage 200.

As a snapshot SS01 representing a first state in which data units “A”, “B”, and “C” are stored in the VVOL 217V, there is a snapshot VOL (SSVOL) 217S1. Here, the “snapshot” (SSVOL) is a virtual copy of a volume (here, the VVOL 217V) at a certain point in time. The first state is a state before the data unit “A'” is overwritten on the data unit “A”.

The SSVOL 217S1 indicates that the data units stored in the VVOL 217V are “A”, “B”, and “C”, and is acquired by copying information in the mapping table 2210. That is, the snapshot can be acquired by duplicating information of an acquisition target volume of the snapshot stored in the mapping table 2210.

Specifically, the SSVOL 217S1 includes information indicating the correspondence relation between the addresses of the three virtual areas 50 and the addresses B00, B01, and B02 of the three real areas 60. The SSVOL 217S1 is registered in the mapping table 218.

Thereafter, when a data unit of the VVOL 217V is rewritten from “A” to “A'” and a time point of this state is a snapshot acquisition time point, SSVOL 217S2 as a snapshot SS02 is acquired. The SSVOL 217S2 indicates that the data units stored in the VVOL 217V at that time are “A'”, “B”, and “C”, and is acquired by copying information in the VVOL 217V at that time (information in the mapping table 218). The SSVOL 217S2 includes information indicating the correspondence relation between the addresses of the three virtual areas 50 in which the three data units are stored and the addresses B03, B01, and B02 of the real area 60 in which the data units “A'”, “B”, and “C” are stored.

According to SSVOL 217S1 and SSVOL 217S2, a correspondence relation between the virtual area 50 and the real area 60 can be specified for the past time point when the snapshot is acquired, and the data unit can be acquired from the specified real area 60. When the data unit “B'” is overwritten in the virtual area 50 in which the data unit “B” is written, the address B04 of the newly secured real area 60 instead of the original virtual area (B01) is associated with an address of the virtual area 50 in which the data unit “B'” is written, and the data unit “B'” is written in the real area 60 of the address B04.

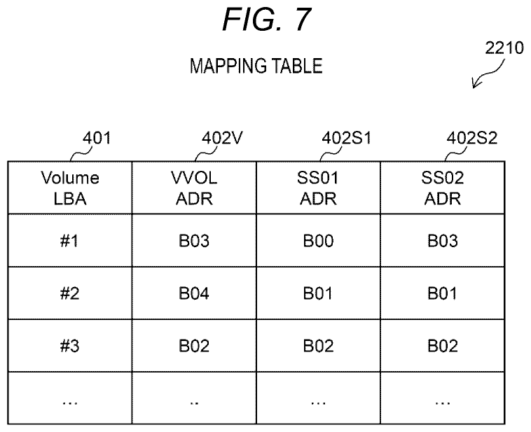

FIG. 7 shows a configuration of the mapping table 2210.

The mapping table 2210 may exist for each VVOL 217V. The mapping table 2210 has a column of VVOL 217V and a column of each SSVOL 217S. As the number of SSVOLs 217S increases, the number of columns increases. The example shown in FIG. 7 corresponds to the example shown in FIG. 6. That is, a column 401 of a logical block address (LBA) as a volume address, a column 402V of VVOL 217V, a column 402S1 of SSVOL 217S1, and a column 402S2 of SSVOL 217S2 are provided.

There is a row for each unit area of the volume. In the column 401, LBAs of unit areas are registered. In the column 402V, a real area address (ADR) assigned to an LBA of the virtual area of the VVOL 217V is registered. In the column 402S, an ADR (real area address) allocated to an LBA of the virtual area of the SSVOL 217S is registered.

In the column 402V, B03, B04, and B02 are registered as ADRs for LBAs #1 to #3 of three virtual areas in which the data units “A'”, “B'”, and “C” are stored.

Since the column 402S1 corresponds to the snapshot SS01 of the VVOL 217V in a state in which the data units “A”, “B”, and “C” are stored, B00, B01, and B02, which are ADRs of the three real areas 60 in which the data units “A”, “B”, and “C” are stored, are registered for LBAs #1 to #3 of the three unit areas.

Since the column 402S2 corresponds to the snapshot SS02 of the VVOL 217V in a state in which the data units “A'”, “B”, and “C” are stored, B03, B01, and B02, which are ADRs of the three real areas 60 in which the data units “A'”, “B”, and “C” are stored, are registered for LBAs #1 to #3 of the three unit areas.

Here, in the backup source storage 200, the real area 60 corresponding to the ADR registered (referred) in the mapping table 2210 is not determined to be a free (unused) real area 60, and the data unit stored in the real area 60 is maintained in a stored state. Therefore, the real areas 60 of B00 to B04 referred to in the mapping table 2210 are not determined to be unused real areas 60, and the data units “A”, “B”, “C”, “A'”, and “B'” of the real areas 60 are maintained in a stored state.

The snapshot SS01 can be acquired by copying information stored in the column 402V to the column 402S1 at the time of snapshot acquisition. The snapshot can be collectively acquired for a plurality of VVOLs 217V instead of one VVOL 217V. In general, backups of a plurality of VVOLs 217V can be acquired in a snapshot group or a consistency group. By collectively operating the snapshot group and the consistency group as groups, the backups at the same time can be acquired. In this case, the mapping table 2210 may include a column in which a group ID of a group to which the VVOL 217V belongs is registered.

The snapshot is acquired (created) by the snapshot acquisition program 2222. The snapshot is deleted by the snapshot deletion program 2223. Each column 402S of the mapping table 2210 may include information indicating a snapshot acquisition time.

Hereinafter, an example of processing performed in the present embodiment will be described.

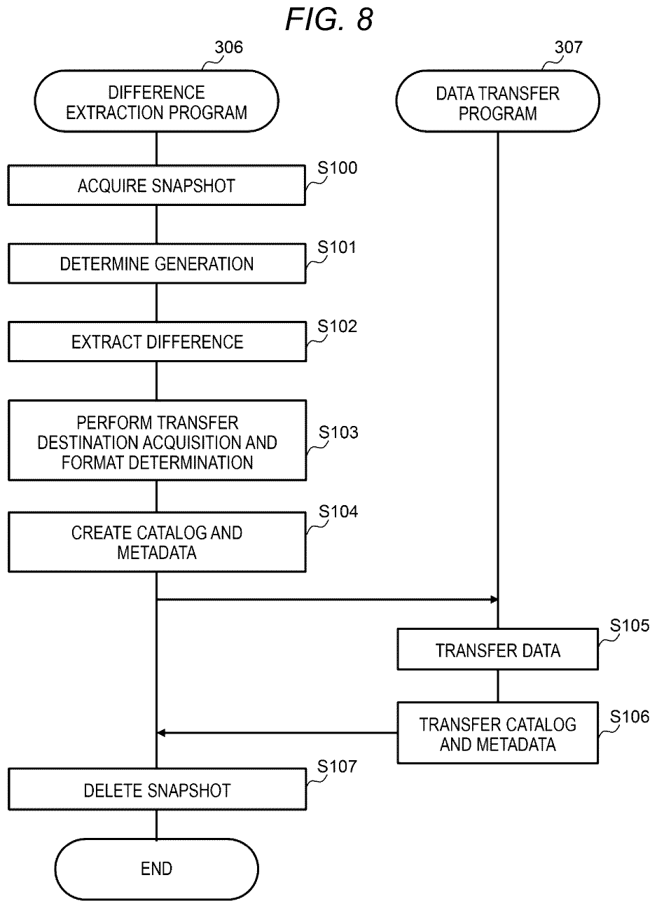

FIG. 8 shows a flow of the backup processing.

The backup processing is performed by the backup server 300. In the backup server 300, the difference extraction program 306 and the data transfer program 307 are programs for backing up data in the backup destination storage 400. The difference extraction program 306 causes the snapshot acquisition program 2222 of the backup source storage 200 to acquire a snapshot of the VVOL 217V periodically (or in response to an explicit request). Specifically, the difference extraction program 306 transmits, to the snapshot acquisition program 2222 of the backup source storage 200, a snapshot acquisition instruction in which a volume number of a snapshot acquisition target (volume number of a VVOL 17V) is designated. The snapshot acquisition program 2222 acquires a snapshot of the VVOL 17V in response to the snapshot acquisition instruction.

The difference extraction program 306 causes the backup source storage 200 to acquire a snapshot (S100). Accordingly, a snapshot is acquired (created) in the backup source storage 200. Specifically, in response to the snapshot acquisition instruction from the difference extraction program 306, the snapshot acquisition program 2222 of the backup source storage 200 adds and initializes a column corresponding to the newly acquired snapshot in the mapping table 2210. Then, the snapshot acquisition program 2222 copies information in the column 402V to the added column 402S.

The difference extraction program 306 determines a generation number of the snapshot acquired in S100 (S101). The “generation” means what number the snapshot is for the VVOL 217V. When a generation is represented by a number, the generation number is incremented in S101.

The difference extraction program 306 performs difference extraction (S102). Specifically, the difference extraction program 306 extracts a difference between the snapshot acquired in the current S100 (a snapshot of the latest generation) and a snapshot (a snapshot of the previous generation) acquired in S100 immediately before S100. This difference is extracted by calling the difference search program 2224 of the backup source storage 200 from the difference extraction program 306. Specifically, in the example of FIG. 6, the difference search program 2224 performs difference search to acquire an LBA in which the data unit “A'” is stored as a difference between the snapshot SS02 of the latest generation and the snapshot SS01 of the previous generation. In the data transfer of S105 to be described later, as a backup of the snapshot SS02 of the latest generation, the common data units “B” and “C” corresponding to no difference are not transferred to the backup destination storage 400, and only the data unit “A'” in the ADR associated with the LBA acquired as a difference is transferred to the backup destination storage 400. As described above, in the example of FIG. 6, the difference between the snapshot SS02 of the latest generation and the snapshot SS01 of the previous generation is an LBA in which the data unit “A'” is stored. When the data unit is written into the VVOL 217V after the snapshot is acquired, a new ADR is associated with the LBA of the write destination in the mapping table 2210. A difference can be extracted (searched) by comparing metadata (for example, data in the columns 402S1 and 402S2) of the snapshot of the previous generation and the snapshot of the latest generation.

The difference extraction program 306 performs transfer destination acquisition and format determination (S103). Specifically, the difference extraction program 306 acquires an ID of the backup destination storage 400 (for example, in a case where the backup destination storage 400 is a storage service in a cloud, information on a transfer destination cloud) and bucket information (information on a backup destination area) from the backup destination management table 305. The difference extraction program 306 determines which data is to be combined into one object according to an object size. In this example, the backup destination storage 400 is an object storage. Similarly, in a case where the backup destination storage 400 is a file storage or a block storage, identification information for identifying an address of a storage destination of data is also acquired.

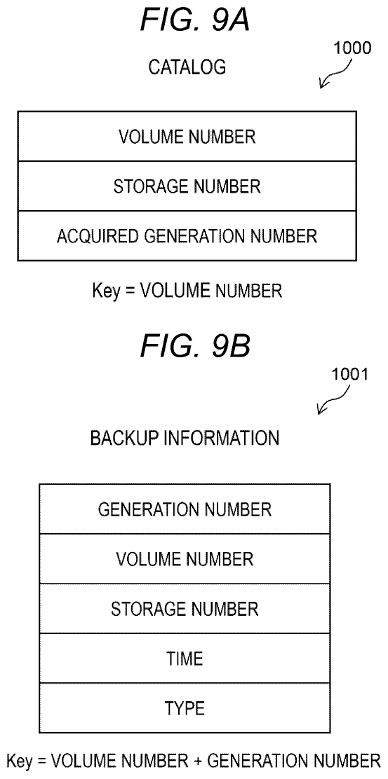

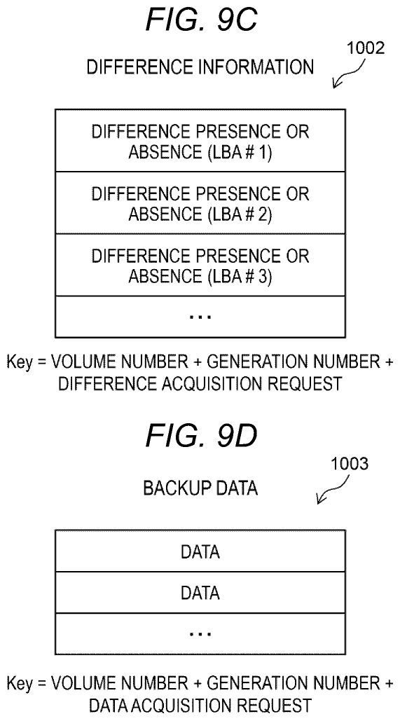

The difference extraction program 306 creates a catalog and metadata (S104). As shown in FIG. 9A, the catalog 1000 is catalog data of metadata, and includes, for example, as shown in FIG. 9A, information indicating a volume number of VVOL 217V, a storage number of the backup source storage 200 having VVOL 217V, and a generation number (acquired generation number) determined in S101. As shown in FIG. 9B, the backup information 1001 as an example of metadata is associated with the catalog 1000, and includes information indicating the generation number determined in S101, the volume number of VVOL 217V, the storage number of the backup source storage 200 having VVOL 217V, a current snapshot acquisition time, and a backup type. In the present embodiment, in the first backup processing, all the data units in the VVOL 217V are backed up (a full backup is performed), and in the subsequent backup processing, the data unit with the difference from the immediately previous snapshot is backed up (an incremental backup is performed). The backup type is full backup or incremental backup. As shown in FIG. 9C, the difference information 1002 as an example of metadata is associated with the catalog 1000 and includes information indicating the presence or absence of a difference for each LBA of a volume. The difference information 1002 may be managed by a data structure other than the data structure shown in FIG. 9C. Specifically, the LBA having a difference may be recorded in the difference information 1002. An LBA that is not recorded in the difference information 1002 may be determined to have no difference.

The data transfer program 307 transfers the backup data to the backup destination storage 400 specified in S103 (S105). The data transfer program 307 also transfers the catalog and the metadata to the backup destination storage 400 specified in S103 (S106). As shown in FIG. 9D, the backup data 1003 is a set of data (data unit) as the difference specified in S102.

The difference extraction program 306 causes the snapshot deletion program 2223 of the backup source storage 200 to delete the previous snapshot (S107). The snapshot (a snapshot of the latest generation) acquired in the S100 in the current backup processing is used in S102 in the next backup processing, and thus is not deleted. Thus, the difference extraction program 306 does not necessarily need to delete all snapshots. When the number of snapshots remaining in the backup source storage 200 is large, the storage capacity consumed in the backup source storage 200 increases, but the number of snapshots serving as starting points for transferring difference data at the time of data recovery increases, and a transfer amount in restoration can be reduced. For example, in a case where the VVOL 217V at 11:00 is restored to the backup source storage 200, if a snapshot at 9:00 is in the backup source storage 200 but snapshots at 9:00 to 11:00 are not in the backup source storage 200, it is necessary to restore the VVOL 217V at 9:00 in the backup source storage 200 and transfer a difference in the snapshots at 9:00 to 11:00 from the backup destination storage 400 to the backup source storage 200. However, if there is another snapshot of 10:00 in the backup source storage 200, only a difference with the snapshot of 10:00 to 11:00 needs to be transferred from the backup destination storage 400, the transfer amount is reduced, and a time required for restoration can be shortened.

In S107, specifically, a snapshot deletion instruction in which a snapshot number of a snapshot to be deleted is designated is transmitted from the difference extraction program 306 to the snapshot deletion program 2223 of the backup source storage 200, and in response to the snapshot deletion instruction, the snapshot corresponding to the designated snapshot number is deleted by the snapshot deletion program 2223. Specifically, the snapshot deletion is to delete (or initialize) the column 402S corresponding to a snapshot to be deleted in the mapping table 2210.

The difference extraction program 306 and the data transfer program 307 described above may be executed by the storage 200, 400, or 900 (for example, a F-I/F in the storage) instead of the backup server 300.

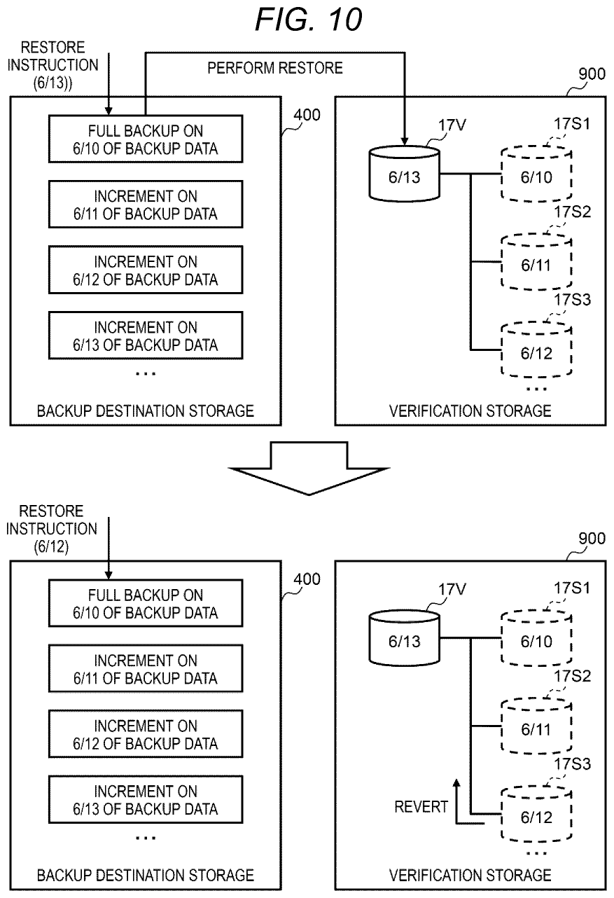

FIG. 10 schematically shows an outline of an example of recovery processing. In FIG. 10, “6/X” means June X of a certain year.

In FIG. 10, the “backup data” refers to backup data in the VVOL 217V. That is, the “backup data” are backup data on 6/10, backup data on 6/11, . . . , and backup data on 6/13 for the VVOL 217V. In the example shown in FIG. 10, data of one VVOL 217V is backed up, but data of a plurality of VVOLs 217V belonging to one group may be backed up. For example, when there are a volume A and a volume B, the backup data on 6/10 includes backup data on 6/10 in the volume A and backup data on 6/10 in the volume B. It is also possible to restore only the volume A or only the volume B by separately managing the backup data in the volume A and the backup data in the volume B.

The backup data on 6/10 as first backup data includes backup data of full backup, that is, data in all virtual areas of the VVOL 217V. However, it may be devised to omit data in an all-zero area.

The backup data on 6/11, 6/12, and 6/13 are incremental backup data. The incremental backup data includes only data updated from the previous backup. The data on 6/12 can be reproduced by overwriting the data on 6/10 with the data on 6/11 and further overwriting the data on 6/12. That is, the data on 6/12 is not directly accessed in the backup destination storage 400. In general, data is reproduced in a storage and the reproduced data is accessed. This reproduction is called “restore”.

When infection with ransomware or the like is suspected, in order to specify uninfected data, backup data is restored from the backup destination storage 400 to the verification storage 900 to check the presence or absence of infection. Restoration of data of different generations and scanning including checking the presence or absence of infection are repeatedly performed until uninfected data is found.

For example, in order to reproduce the latest state as much as possible, backup data of the latest generation is restored and the presence or absence of infection is checked. When the generation is infected, the backup of the next new generation (the previous generation) is restored and the presence or absence of infection is checked. According to the example shown in FIG. 10, the backup server 300 is instructed to restore the backup data on 6/13, which is the latest generation, and the backup server 300 restores the backup data on 6/13. Thereafter, the backup server 300 is instructed to restore the backup data on 6/12, which is the next new generation, and the backup server 300 restores the backup data on 6/12.

In one comparative example, in order to restore the data on 6/13, the backup data on 6/10, 6/11, 6/12, and 6/13 are transferred from the backup destination storage 400 to the verification storage 900. Thereafter, in order to restore the data of the next new generation 6/12, the backup data on 6/10, 6/11, and 6/12 is transferred from the backup destination storage 400 to the verification storage 900. In this way, in a case where, after restoring data of a desired generation, restoration of data of a past generation is sequentially repeated until uninfected data is found, data of a generation that has been transferred to the verification storage 900 is repeatedly performed in restoration. Since at least the transfer of the full backup data is repeated, a data transfer amount until uninfected data is found is large, and the time required for restoration is long.

Therefore, in the present embodiment, a time required for restoration can be shortened by the following processing.

That is, when the backup server 300 receives a restore instruction of the data on 6/13, which is the latest generation, the backup server 300 causes the verification storage 900 to create a restore destination VOL 17V (VVOL in the present embodiment), and writes the full backup data on 6/10 from the backup destination storage 400 to the restore destination VOL 17V of the verification storage 900.

Next, the backup server 300 causes the verification storage 900 to acquire a snapshot of the restore destination VOL 17V. An image of the restore destination volume 17V on 6/10 minutes is stored as a snapshot (a SSVOL 17S1).

Next, the backup server 300 overwrites the restore destination VOL 17V of the verification storage 900 with incremental backup data on 6/11 from the backup destination storage 400. In the restore destination VOL 17V, the LBA of the write destination of each data unit in the incremental backup data is the same LBA as the LBA of the data unit (an LBA of the virtual area in the VVOL 217V).

Next, the backup server 300 causes the verification storage 900 to acquire a snapshot of the restore destination VOL 17V. An image of the restore destination volume 17V on 6/11 minutes is stored as a snapshot (a SSVOL 17S2).

As described above, the restoration of the incremental backup data and the acquisition of the snapshot (a SSVOL 17S) of the restore destination VOL 17V overwritten with the incremental backup data are repeated. This repetition is performed until the incremental backup data on 6/13 is overwritten in the restore destination VOL 17V. In this repetition, the mapping table 2210 is created and updated in the verification storage 900. Specifically, the column 402V is added by writing the backup data of full backup, and the column 402S is added every time the snapshot is acquired. That is, in the mapping table 2210 of the verification storage 900, the column 402V has an address (ADR) of a real area of a capacity pool in the verification storage 900 for each LBA of the restore destination VOL 17V in which the full backup data at the time of 6/10 is written. The column 402S has an address (ADR) of a real area of a capacity pool in the verification storage 900 for each LBA of the SSVOL 17S acquired in the verification storage 900.

The upper half of FIG. 10 shows a state in which the data on 6/13 (data at the time of 6/13) is restored in the restore destination VOL 17V. Although a snapshot on 6/13 is not acquired in the shown example, a snapshot on 6/13 may be acquired. The snapshot and information of a backup generation acquired (created) in the verification storage 900 are registered in the restored snapshot management table 304.

Next, the backup server 300 checks the presence or absence of infection of the restored data on 6/13. As a result of the check, when the data on 6/13 is infected, as shown in the lower half of FIG. 10, the backup server 300 receives a next new restore instruction on 6/12. For example, the backup server 300 may output, to an instruction source of the restore instruction on 6/13, information (for example, display information) indicating that the data on 6/13 is infected, and may receive the next new restore instruction on 6/12 after the output of the information.

In response to the restore instruction on 6/12, the backup server 300 causes the verification storage 900 to reflect, in a restore destination volume, a snapshot (a SSVOL 17S3) on 6/12 acquired in the verification storage 900. This processing is called “revert”. Revert is implemented only by updating the mapping table 2210 in the verification storage 900. Revert is performed by the revert program 2225. Specifically, the backup server 300 causes the revert program 2225 of the verification storage 900 to overwrite the column 402V with information in the column 402S corresponding to the snapshot on 6/12. That is, the association (mapping) of a real area with a virtual area in the restore destination VOL 17V is updated. As described above, since data can be reproduced without copying actual data in the verification storage 900 (since data can be reproduced by changing the association of the real area with the virtual area in the restore destination VOL 17V), data on 6/12 can be reproduced at a high speed.

As described above, in the processing of restoring the data on 6/13, which is the latest generation, the data on 6/10, 6/11, and 6/12 is acquired as a snapshot, and the backup generation and the snapshot are managed in association with each other, so that a copy amount of data can be reduced, and a time for checking the presence or absence of infection can be shortened.

In the present embodiment, the data of 6/10, 6/11, 6/12, and 6/13 can be stored as snapshots in the verification storage 900. That is, data of the address not updated is physically shared between the data on 6/10 and the data on 6/11. Therefore, a storage cost of the verification storage 900 can be reduced.

Furthermore, in a case where the backup destination storage 400 is a storage in the cloud (for example, storage outside the data center 1) and the verification storage 900 is installed in the data center 1, it is expected to reduce a cost generated for data transfer from the cloud to the verification storage 900.

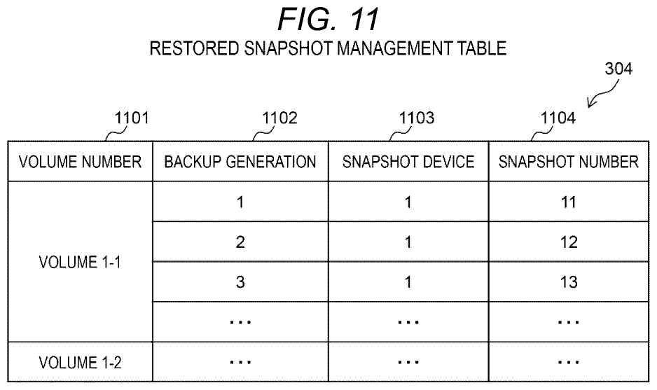

FIG. 11 shows a configuration of the restored snapshot management table 304.

The restored snapshot management table 304 includes a column 1101 of volume number, a column 1102 of backup generation, a column 1103 of snapshot device, and a column 1104 of snapshot number. Each row of the restored snapshot management table 304 corresponds to a restored snapshot (in the example of FIG. 10, SSVOs 17S1 to 17S3).

In the column 1101, a number for identifying a volume to be backed up is registered. A column of numbers for identifying the storage having the volume may be added. In the present embodiment, it is assumed that a volume 1-1 is a volume 1 of the storage 1, and an identification number of a storage and an identification number of a volume are linked to each other.

A backup generation of a volume identified according to a volume number is registered in the column 1102. The backup generation may be a generation number as described above, or may be a date, time, or the like instead of a number.

In the column 1103, the identification number of the storage that acquires a snapshot is registered. In the present embodiment, an identification number of the verification storage 900 is registered in the column 1103 as an identification number of the snapshot device.

The column 1104 shows snapshot numbers identified by the snapshot device. The snapshot numbers are numbers for identifying a plurality of snapshots in the verification storage 900 described above.

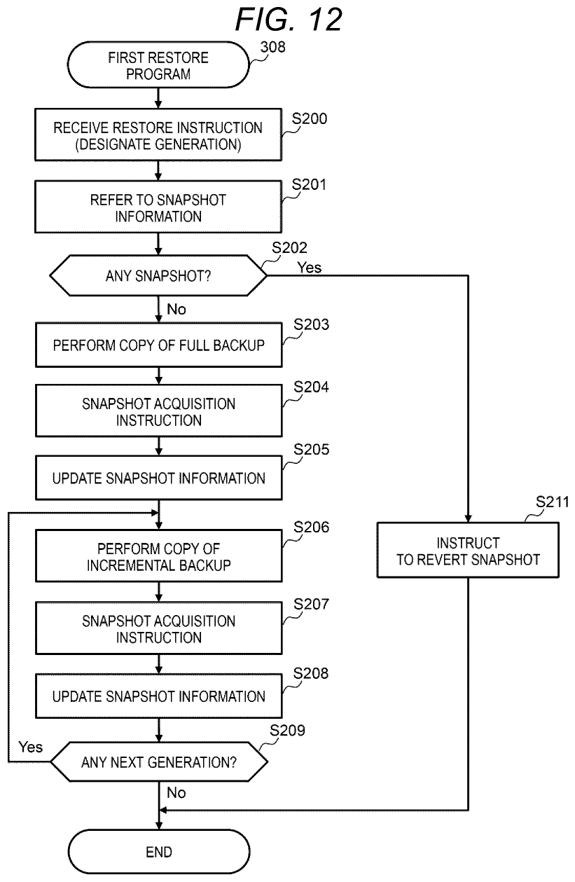

FIG. 12 shows a flow of processing executed by the first restore program 308.

The first restore program 308 receives a restore instruction (S200). In the restore instruction, a volume number of a target volume (VVOL 217V) and a generation are designated. In addition, in the restore instruction, a storage number of the verification storage 900 and a volume number of the restore destination VOL may be designated. The first restore program 308 may determine the storage number of the verification storage 900 and the volume number of the restore destination VOL, and may return these numbers to an instruction source of the restore instruction as a processing result.

The first restore program 308 refers to snapshot information corresponding to the designated generation (S201). The “snapshot information” referred to here is information that is updated (created) in S205 or S208, which will be described later, and specifically is information of a row having backup generation information (information indicating a backup generation) that matches a designated generation (generation designated by a restore instruction received in S200) in the restored snapshot management table 304.

The first restore program 308 determines whether there is snapshot information corresponding to the designated generation (S202). For example, according to the description with reference to FIG. 10, when the restore instruction received in S200 is a restore instruction received for the first time (that is, when the processing shown in FIG. 12 is the processing performed for the first time), the determination result in S202 is false. On the other hand, when the restore instruction received in S200 is a restore instruction in which the presence of infection is detected from the data reproduced in response to the previous restore instruction and a generation older than the generation designated by the previous restore instruction is designated, the determination result of S202 is true.

When the determination result in S202 is false (S202: No), the first restore program 308 copies the backup data of full backup (data on 6/10 in FIG. 10) from the backup destination storage 400 to the restore destination VOL 17V of the verification storage 900 (S203). “Copy” in this paragraph means reading data from the backup destination storage 400 and writing the data to the restore destination VOL 17V. By accessing the catalog 1000 and the backup information 1001 shown in FIGS. 9A and 9B and referring to information on a generation number and a type, generation information of the full backup and the backup data 1003 of the full backup can be acquired.

The first restore program 308 transmits a snapshot acquisition instruction for acquiring a snapshot of the restore destination VOL 17V to the snapshot acquisition program 2222 of the verification storage 900 (S204). Accordingly, the snapshot (SSVOL 17S1) of the restore destination VOL 17V (data on 6/10) to which the data of the full backup is copied is acquired in the verification storage 900 by the snapshot acquisition program 2222.

The first restore program 308 updates the restored snapshot management table 304 (S205). Specifically, for example, a row corresponding to the oldest backup generation is added to the restored snapshot management table 304.

The first restore program 308 overwrites and copies the incremental backup data corresponding to the next generation of the immediately preceding generation from the backup destination storage 400 to the restore destination VOL 17V (S206).

The first restore program 308 transmits a snapshot acquisition instruction for acquiring a snapshot of the restore destination VOL 17V to the snapshot acquisition program 2222 of the verification storage 900 (S207). Accordingly, a snapshot (for example, SSVOL 17S2) of the restore destination VOL 17V (for example, data on 6/11) to which the incremental backup data is copied in S206 is acquired in the verification storage 900 by the snapshot acquisition program 2222. The first restore program 308 updates the restored snapshot management table 304 (S208). Specifically, for example, a row corresponding to the backup generation of the incremental backup data copied in S206 is added to the restored snapshot management table 304.

The first restore program 308 determines whether there is a next generation (S209). Specifically, if the backup generation of the incremental backup data copied in the immediately preceding step S206 does not match the designated generation, the determination result in S209 is true. If the determination result in S209 is true (S209: Yes), the processing returns to S206, and the incremental backup data of the next generation of the backup generation of the incremental backup data copied in the immediately preceding step S206 is copied.

On the other hand, if the backup generation of the incremental backup data copied in the immediately preceding step S206 matches the designated generation, the determination result in S209 is false. If the determination result in S209 is true (S209: No), the processing ends.

If the determination result in S202 is false (S202: No), the first restore program 308 transmits a snapshot revert instruction to the revert program 2225 of the verification storage 900 (S211). When the designated generation is a full backup generation, the processing may be ended immediately after step S203 or S206. This is achieved by adding processing corresponding to S209 immediately after S203 or S206.

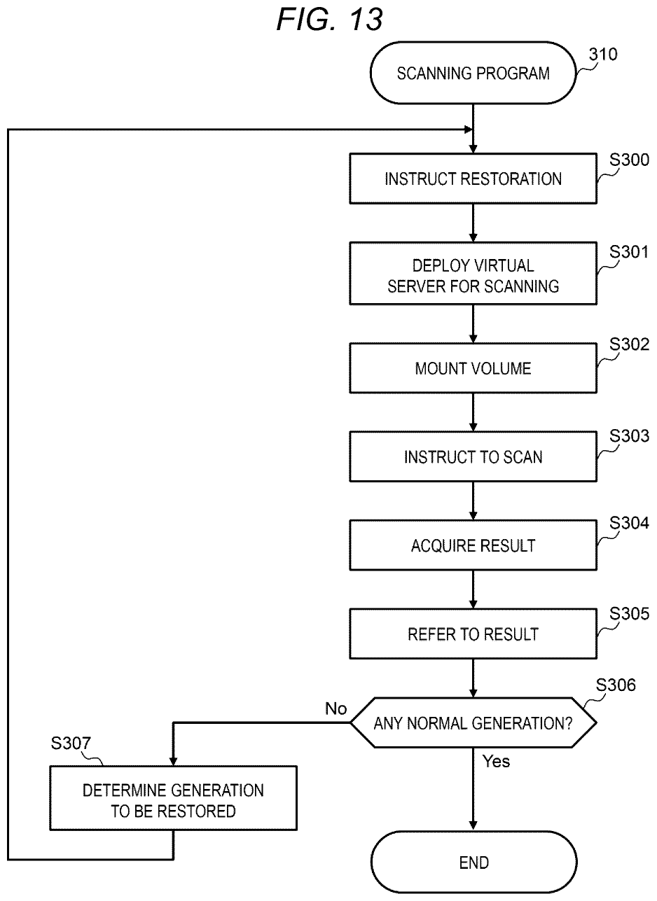

FIG. 13 shows a flow of processing performed by the scanning program 310.

The scanning program 310 is a program for constructing an environment for checking whether data reproduced by the first restore program 308 (or a second restore program 309 to be described later) is infected, and issuing a scan instruction. The scanning itself may be achieved by calling an existing check function of a so-called virus check program or the like. Although the first restore program 308 is taken as an example in the illustration of FIG. 13, the first restore program 308 may be read as the second restore program 309 in the illustration of FIG. 13.

The scanning program 310 issues a restore instruction to the first restore program 308 (S300). For example, in a first restore instruction, a latest backup generation is designated. A plurality of generations may be designated in one restore instruction. A backup generation may be designated by a user via the I/O unit 272, or the latest backup generation, the next old backup generation, or the like may be specified by the scanning program 310 from the catalog and metadata stored in the backup destination storage 400, and the specified generation may be designated by the scanning program 310.

The scanning program 310 deploys a virtual server for scanning (S301). The virtual server is a server for mounting a volume in which scan target data is stored and executing the existing check function (for example, a virus check program) on data of the volume. A deployment destination of the virtual server may be any device, for example, the backup server 300 or the verification storage 900.

The scanning program 310 mounts a volume in which the scan target data is stored on the deployed virtual server (S302). The volume to be mounted is the restore destination VOL 17V in which data of the designated generation is reproduced in response to the restore instruction in S300.

The scanning program 310 instructs the existing check function to start scanning data of the mounted volume (check the presence or absence of infection) (S303). When the scan of the data ends, the scanning program 310 acquires a scan result from the existing check function (S304). The scanning program 310 refers to the scan result (S305), and determines whether the designated generation is a normal generation (S306). If the determination result in S306 is true (S306: Yes), the processing ends.

When the determination result in S306 is false (S306: No), the scanning program 310 determines a generation older than the generation designated by the restore instruction of the immediately preceding step S300 (S307), and issues a restore instruction designating the generation determined in S307 (S300). That is, after S307, the processing returns to S300. The generation determined in S307 may be the latest generation (for example, a generation one older than the immediately preceding designated generation) among the generations that are not designated. In S307, a plurality of generations may be determined.

The processing shown in FIGS. 12 and 13 will be described based on the example shown in FIG. 10, for example, as follows. That is, although a generation corresponding to 6/13 is designated in the first restore instruction, since infection is detected from the scan result of the reproduced and scanned data, an oldest generation, that is, a generation corresponding to 6/12 is determined in S307, and a restore instruction in which the determined generation is designated is issued in S300. In the reproduction of the data on 6/13, the snapshot of the data on 6/12 has been restored. Therefore, in the reproduction of the data on 6/12, copying from the backup destination storage 400 to the verification storage 900 is unnecessary. That is, S211 is performed after S202: Yes. By reverting the data on 6/12 to the restore destination VOL 17V (only by copying between columns in the mapping table 2210), the data on 6/12 can be reproduced in the restore destination VOL 17V.

In the processing shown in FIGS. 12 and 13, scanning is performed each time data of a designated generation is reproduced. That is, scanning is sequentially performed. The scanning program 310 may be included in the first restore program 308.

On the other hand, the second restore program 309 performs scanning in parallel. Accordingly, the scan processing of the presence or absence of infection can be further increased. The scanning program 310 may also be included in the second restore program 309.

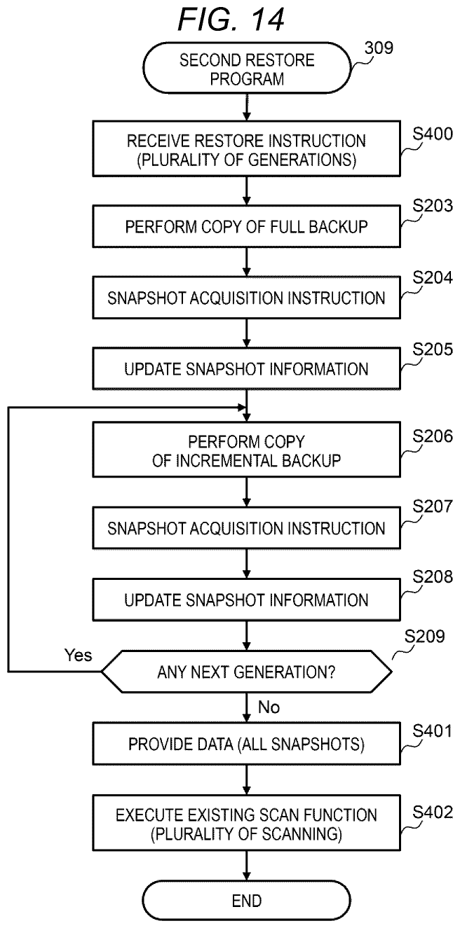

FIG. 14 shows a flow of processing performed by the second restore program 309.

A difference from the processing shown in FIG. 12 is that S400 to S402 exist instead of S200 to S202 and S211, and S203 to S209 are the same as S203 to S209 shown in FIG. 12. Therefore, S400 to S402 will be mainly described.

In S400, the second restore program 309 receives a restore instruction for designating a plurality of generations. That is, in the restore instruction, a plurality of generations are designated as restore targets for the same VVOL 217V. The second restore program 309 provides an interface for receiving a plurality of generations for the same VVOL 217V. This interface may be, for example, a graphical user interface (GUI), may be displayed on the I/O unit 272, and a plurality of generations may be designated via the GUI displayed on the I/O unit 272. Alternatively, for example, this interface may be provided to the scanning program 310, and a plurality of generations determined by the scanning program 310 based on the catalog and metadata stored in the backup destination storage 400 may be designated from the scanning program 310 via the interface. According to the example shown in FIG. 10, for example, four generations corresponding to 6/10 to 6/13 may be designated to be the plurality of generations.

In S401, the second restore program 309 provides a snapshot (SSVOL 17S) in addition to the restore destination VOL 17V to a virtual server deployed by the scanning program 301. Here, VOLs of a plurality of designated generations (restore destination VOL and snapshot) are provided. According to the example shown in FIG. 10, four VOLs (VOL 17V and SSVOL 17S1 to 17S3) corresponding to 6/10 to 6/13 are provided. The term “provide” as used herein refers to a state in which “mounting” described with reference to FIG. 13 is possible. For example, in order to enable access from a virtual server to a VOL, a volume number (for example, LUN) of a snapshot or the like is assigned to the virtual server, and setting of a port (setting of an access route for enabling access from which port to the VOL) is performed. Further, an administrator may designate a LUN or the like of a restore destination. In this case, the LUN designated by the administrator in S401 may be associated with a snapshot.

The processing shown in FIG. 14 indicates reproduction of a plurality of consecutive generations, but the plurality of generations need not be consecutive generations. In this case, S204 and S205 or S207 and S208 may be skipped for a generation that is not included in the plurality of designated generations. When the designated generation is a full backup generation, the processing may be ended immediately after step S203 or S206. This is achieved by adding processing corresponding to S209 immediately after S203 or S206.

In S402, the second restore program 309 instructs an existing scan function to execute scan processing in parallel for all VOLs (for example, VOL 17V and SSVOLs 17S1 to 17S3) corresponding to the designated plurality of generations. Therefore, the existing scan function is notified of the volume numbers (snapshot numbers) of all VOLs corresponding to the designated plurality of generations. When N generations of scans are designated, the scanning program 310 deploys N virtual servers in S301. In S302, a VOL of each generation is mounted on each of the deployed N virtual servers. In S303, the deployed N virtual servers are instructed to start scanning a scan target VOL of each virtual server. In S304, a result is acquired from each virtual server. Step S300 is unnecessary. Step S300 shows an instruction for reproducing a generation to be scanned in the VOL 17V. This is because scanning is performed by accessing a snapshot (S17S1, S172, or the like) in scanning of a plurality of generations. The second restore program 309 may specify a generation without infection based on the scan result from the existing scan function, and reproduce data of the latest generation of the generations without infection in the restore destination VOL 17V.

The restore destination VOL 17V in which data without infection is reproduced may be provided to the server 100 and set as an I/O destination in the business processing by the server 100. Further, the restore destination VOL 17V in which the data without infection is reproduced may be copied from the verification storage 900 to another storage (for example, backup source storage 200) by the first restore program 308 or the second restore program 309, and a copy destination VOL in the other storage may be provided to the server 100 and set as the I/O destination in the business processing by the server 100.

Although the storage system according to the embodiment is the data center 1, the storage system includes, for example, the following modifications.

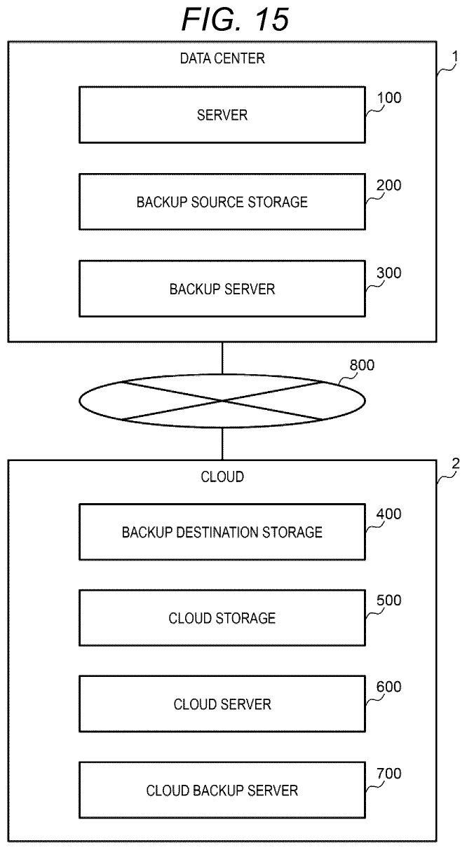

FIG. 15 shows a configuration of a storage system according to a first modification.

The data center 1 includes the server 100, the backup source storage 200, and the backup server 300. The backup destination storage 400 is provided in the cloud 2. The cloud 2 further includes a cloud storage 500, a cloud server 600, and a cloud backup server 700.

The cloud storage 500 is a storage device used as the verification storage 900. The cloud storage 500 may be constructed on a software basis by combining servers and storages provided by the cloud 2. The cloud storage 500 may be a storage device as one of cloud computing services provided by the cloud 2. The cloud storage 500 is a storage as an SDS.

The cloud server 600 may be a server that executes scanning or a server that is used when the cloud 2 side takes over a business from the server 100. When scanning is executed, the existing scan function is executed. In the case of taking over the business, an application or the like executed by the server 100 is executed by the cloud server 600.

The cloud backup server 700 is a server that restores backup data instead of the backup server 300. Although the cloud backup server 700 may not be provided, a configuration in which the cloud backup server 700 is provided may be preferable for the following reason.

Instead of reading the backup data from the backup destination storage 400 to the backup server 300 outside the cloud 2 and writing data from the backup server 300 outside the cloud 2 to the cloud storage 500, data transfer from the backup destination storage 400 to the cloud storage 500 in the cloud 2 is achieved by the cloud backup server 700. Accordingly, data to be transferred in the data transfer does not go out of the cloud 2.

Since the backup server 300 itself is infected with ransomware, the backup server 300 cannot be used.

The present invention can also be applied to a configuration in which elements 500, 600, and 700 are not in the cloud 2 and only the backup destination storage 400 is in the cloud 2. That is, in the configuration, the server 100, the backup source storage 200, and the backup server 300 exist in the data center 1, and the backup destination storage 400 exists in the cloud 2. When the present invention is applied to such a configuration, an amount of backup data transferred from the cloud 2 to the data center 1 can be reduced. Furthermore, since data transfer from the cloud 2 to the outside of the cloud 2 may be charged, not only a restoration speed but also a cost reduction effect can be expected.

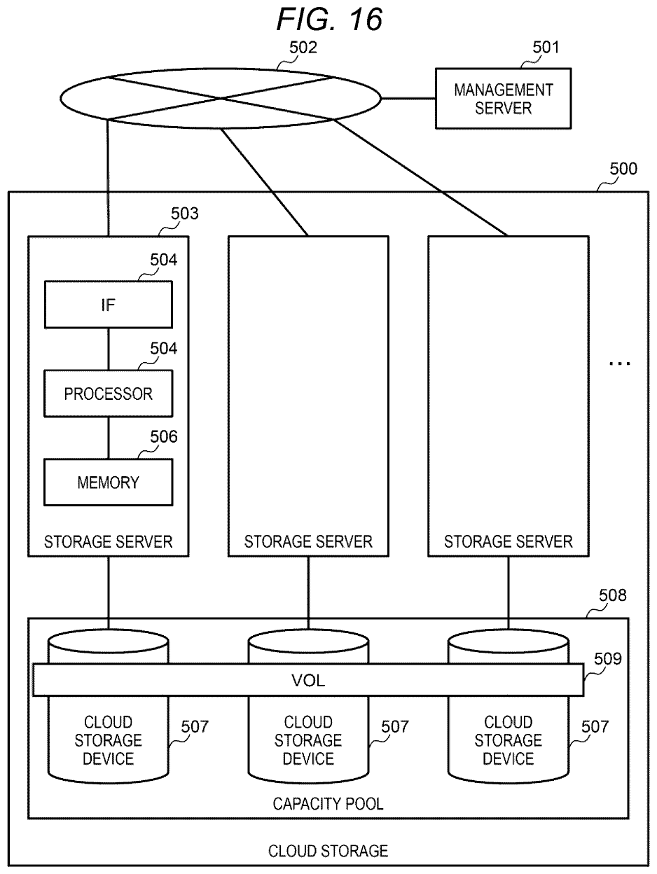

As another configuration, the data center 1 may be the cloud 2. That is, a configuration may be adopted in which the server 100, the backup source storage 200, the backup server 300, and the backup destination storage 400 are provided in the cloud 2. The data center 1 and the cloud 2 may have reverse configurations. Specifically, for example, the following can be considered for each of (A) a subject of backup processing, (B) a backup destination storage, and (C) a verification storage. The combination of (A), (B), and (C) may be any combination. Specifically, FIG. 1 shows (a3)+(b1)+(c1). FIG. 15 shows (a3)+(b2)+(c4).
(A) A subject of the backup processing
(a1) The backup source storage 200 itself (for example, a processor)
(a2) A F-I/F included in the backup source storage 200
(a3) The backup server 300
(B) A backup destination storage
(b1) A storage different from the backup source storage 200 of the data center 1
(b2) A storage as a storage service (for example, an object storage service, a file storage service, or a block storage service) of the cloud 2
(b3) An SDS that operates in the cloud 2 (see, for example, FIG. 16)
(C) A verification Storage
(c1) A storage different from the backup source storage 200 of the data center 1
(c2) The backup source storage 200 of the data center 1
(c3) A storage as a storage service (for example, an object storage service, a file storage service, or a block storage service) of the cloud 2
(c4) An SDS that operates in the cloud 2 (see, for example, FIG. 16)

FIG. 16 shows a configuration of the cloud storage 500.

The cloud storage 500 includes a plurality of storage servers 503 connected to and bundled with a network 502 in the cloud 2. The network 502 may be the network 230 or a network connected to the network 230. The cloud storage 500 as the SDS is achieved by operating software that performs storage processing on each storage server 503.

Each storage server 503 is connected to the cloud server 600, receives an I/O request (a write request/read request) from the cloud server 600, and performs I/O on a VOL 509 provided by the cloud storage 500. The storage server 503 may include at least one of a physical server, a virtual machine, a container, and the like. The storage server 503 includes, for example, an interface (IF) 504, a processor 504, and a memory 506.

The cloud storage 500 includes one or a plurality of cloud storage devices 507 constituting a capacity pool 508. The cloud storage device 507 is a storage area managed by the storage server 503. For example, in a public cloud, the cloud storage device 507 may be a storage device created from a storage service of the public cloud (for example, an elastic block store (EBS) provided by AWS (registered trademark)). When a storage device created by a storage service is attached to the storage server 503, the storage server 503 can handle the storage device as a built-in drive of the storage server 503.

The VOL 509 (for example, a VVOL) is provided based on the capacity pool 508. Data to be written to the VOL 509 may be made redundant between two or more storage servers 503, may be simply duplicated, and a technique such as Erasure Conding may be used for the redundancy. Since this type of technique is known, a detailed description thereof will be omitted in the present specification.

The management server 501 connected to the network 502 may be a server for managing and maintaining the cloud storage 500. Any of the storage servers 503 may serve as the management server 501.

In the present modification, the cloud storage 500 is an SDS, and a storage such as the backup source storage 200 may operate in the cloud 2. Each storage server 503 may include dedicated hardware, for example, hardware for compression/decompression and hardware for encryption/decryption.

The storage servers 503 may be installed in different availability zones of a public cloud. Even if one availability zone fails, the other availability zones are not affected by the failure. The cloud server 600 and the cloud storage 500 may exist in different availability zones or may exist in different regions. The cloud server 600 and the cloud storage 500 may be on a cloud service (for example, a VMware Cloud on AWS) provided by another vendor on a public cloud vendor. The cloud server 600 and the cloud storage 500 may exist in different clouds 2.

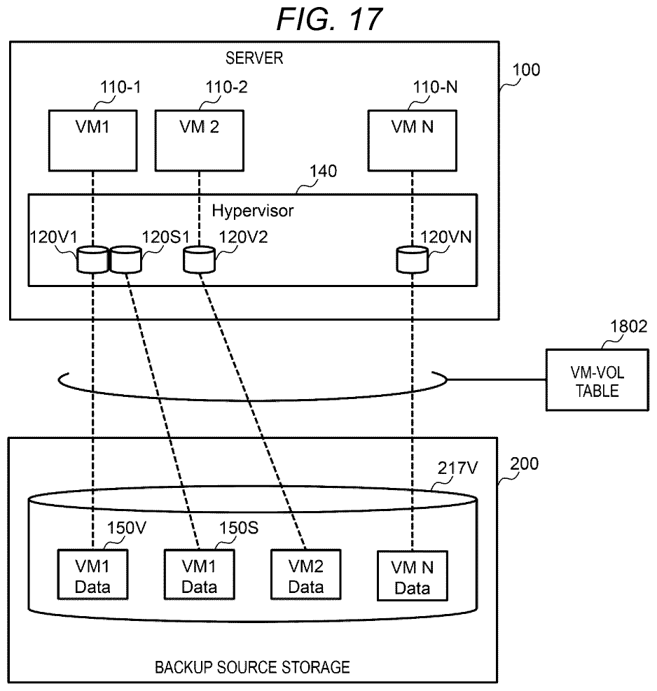

FIG. 17 shows a configuration of a part of a storage system according to a second modification.

In the second modification, a virtualization environment is constructed on the server 100. Depending on a virtualization platform (for example, a hypervisor 140), the VVOL 217V of the backup source storage 200 and data of VMs (virtual machine) 110 may not correspond to 1:1. In the example shown in FIG. 17, a plurality of pieces of data 150 in the VMs 110 are mixed in one VVOL 217V in the backup source storage 200. The VM 110 may be a container.

According to the example shown in FIG. 17, when the VVOL 217V itself is backed up, all the VM data 150 in the VVOL 217V are backed up. In the restoration, all the VM data 150 are restored. Therefore, it is difficult to reproduce data of any generation for each VM. For example, it is difficult to reproduce data on 6/10 for a VM 1 and data on 6/11 for a VM 2.

In such a case, backup in units of VMs can be acquired in cooperation with the virtualization platform. The hypervisor 140 manages a VM storage area 120 (for example, a drive) of the VM for each VM 110. A dotted line between the VM 110 and the VM storage area 120 indicates that the VM storage area 120 is allocated to the VM 110.

A delta area 120S may be provided as the VM storage area 120 for each VM 110 in addition to the base area 120V. For example, a delta area 120S1 is a storage destination area of new write data generated for the base area 120V of the VM 1 when a snapshot of the VM 1 is acquired.

The VVOL 217V includes VM data 150 for each VM 110. The VM data 150 is data stored in the VM storage area 120. The VM data 150 may include delta data 150S, which is data stored in the delta area 120S, in addition to the base data 150V, which is data stored in the base area 120V.

For each VM 110, a correspondence relation between the VM storage area 120 provided by the hypervisor 140 (an example of a virtualization platform) in the server 100 and the VM data 150 in the VVOL 217V is represented in a VM-VOL table 1802.

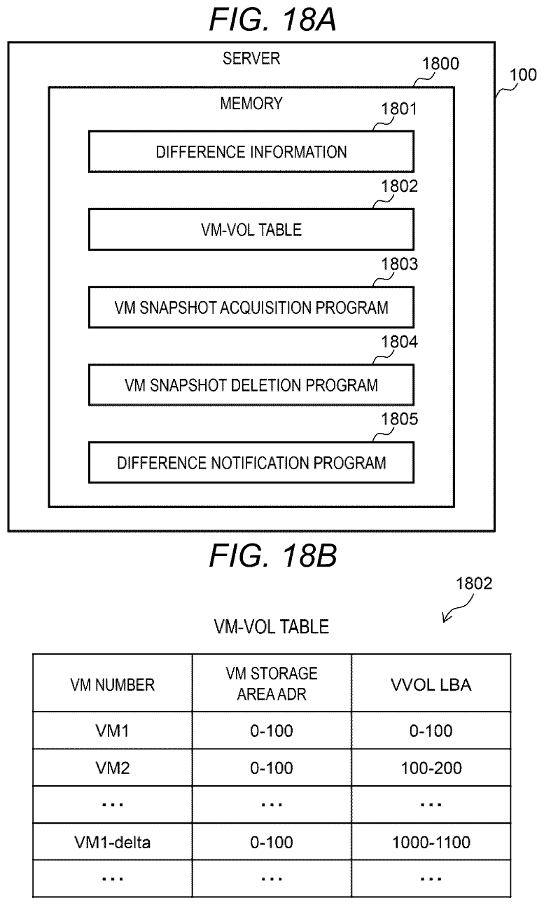

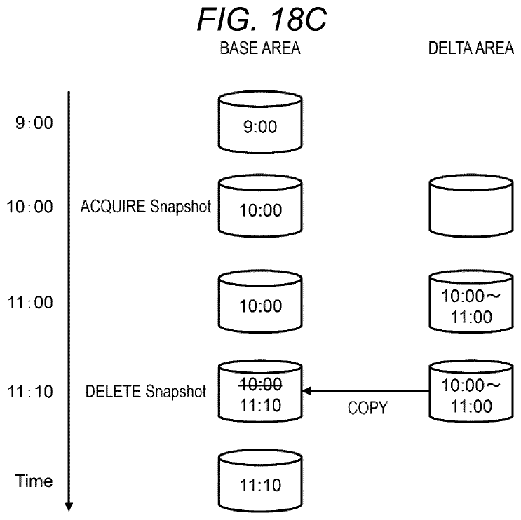

FIG. 18 shows a configuration of the server 100 according to the second modification.

The server 100 includes a memory 1800. Although not shown, the server 100 includes an interface device and a processor in addition to the memory 1800. The program in the memory 1800 is executed by the processor. Communication such as issuance of an I/O request is performed via the interface device.

The memory 1800 stores difference information 1801, the VM-VOL table 1802, a VM snapshot acquisition program 1803, a VM snapshot deletion program 1804, and a difference notification program 1805.

The difference information 1801 records an update address performed on the VM storage area 120. The difference information 1801 can be managed by a bitmap such as 1 bit in units of several kilobytes to several hundred kilobytes. When the backup is performed, the difference information 1801 is returned to an initial state, and the difference after the backup acquisition is recorded in the difference information 1801. Accordingly, it is possible to manage the address updated before the next backup.

The VM-VOL table 1802 is a table representing a correspondence relation between an address of the VM storage area 120 and an LBA of the VVOL 217V. Specifically, as shown in FIG. 18B, the VM-VOL table 1802 indicates, for each VM 110, a VM number (identification number of the VM 110), the address of the VM storage area 120 (base area 120V and delta area 120S), and the LBA in the VVOL 217V.

The VM snapshot acquisition program 1803 acquires a snapshot for each VM 110. The VM snapshot may be acquired by creating the delta area 120S. All the data for updating the base area 120V is stored in the delta area 120S. For example, as shown in FIG. 18C, when a snapshot is acquired at 10:00 for the base area 120V, the update of the base area 120V stops at 10:00. Data written after 10:00 is written in the delta area 120S. By accessing the base area 120V, the VM data at the time of 10:00 can be accessed. The latest VM data can be accessed by accessing the delta area 120S and accessing the base area 120V for data not present in the delta area 120S.

The VM snapshot deletion program 1804 deletes the VM snapshot. For example, as shown in FIG. 18C, the VM snapshot deletion program 1804 copies (overwrites) data stored in the delta area 120S (data written from 10:00 to 11:00) to the base area 120V. At this time, the state of the base area 120V becomes a state of the current time (11:10) when the copying is completed. Thereafter, the VM snapshot deletion program 1804 deletes the delta area 120S.

The difference notification program 1805 notifies external software of the difference information 1801. The difference notification program 1805 acquires the update address on the VM storage area 120 from the difference information 1801, specifies the LBA of the VVOL 217V from the VM-VOL table 1802 using the address, and returns the specified LBA to a request source.

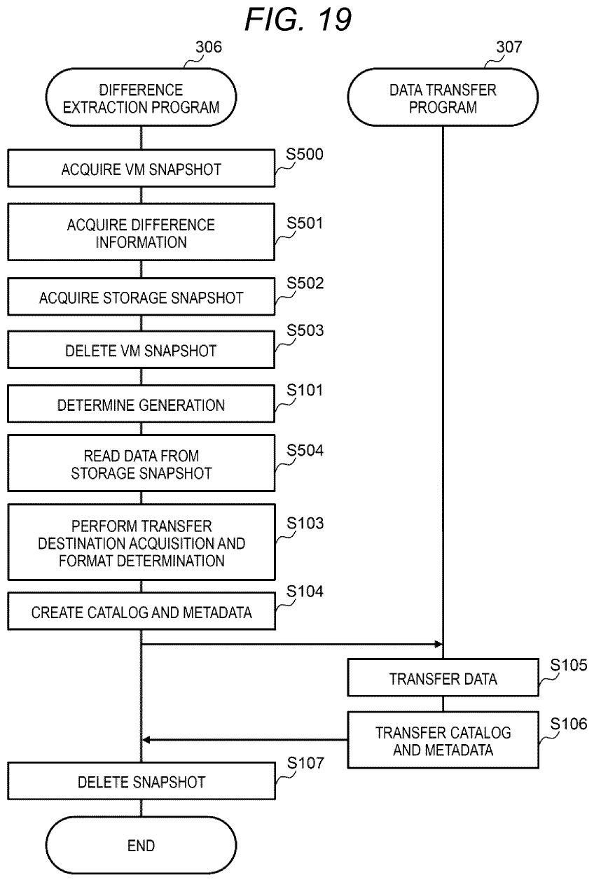

FIG. 19 shows a flow of backup processing according to the second modification.

A difference from the backup processing shown in FIG. 8 is that S500 to S504 exist instead of S100 and S102, and S101 and S103 to S107 are the same as S101 and S103 to S107 shown in FIG. 8. Therefore, S500 to S504 will be mainly described.

In S500, the difference extraction program 306 instructs the VM snapshot acquisition program 1803 of the server 100 to acquire (create) a VM snapshot. In this instruction, a VM number of a target VM is designated. When the VM snapshot acquisition program 1803 acquires the VM snapshot (delta area 120S) of the target VM in response to the instruction, the update of the VM data 150 is stopped. The VM data at this time can be determined. Data (update) for VM data after S500 is stored in VM data 150S (VM delta) as difference data in the VVOL 217V through the delta area 120S.

In S501, the difference extraction program 306 calls the difference notification program 1805 of the server 100 to acquire the difference information 1801. The difference notification program 1805 acquires the update address on the VM storage area 120 recorded in the difference information 1801, specifies the LBA corresponding to the update address from the VM-VOL table 1802, and returns the specified LBA (LBA of VVOL 217V) to the difference extraction program 306.

In S502, the difference extraction program 306 causes the backup source storage 200 to acquire a snapshot. S502 may be the same as S100 in FIG. 8. At this time, the difference extraction program 306 may instruct the difference notification program 1805 to clear (initialize) the difference information 1801, thereby clearing the difference information 1801.

In S503, the difference extraction program 306 instructs the VM snapshot deletion program 1804 of the server 100 to delete the VM snapshot acquired in S500. At this time, the server 100 stops storing data in the delta area 120S, and the VM snapshot deletion program 1804 copies the data stored in the delta area 120S to the base area 120V. The update of the base area 120V by this copy is also recorded in the difference information 1801.

In S504, the difference extraction program 306 reads data from the snapshot acquired in S502 using the LBA corresponding to the update address acquired in S501. Accordingly, data updated after the previous backup processing can be read. The server 100 starts recording the update generated after S500 for the next backup processing.

According to the second modification, the backup data can be stored in the backup destination storage 400 for each VM by the above processing. Restoration of backup data can also be performed in VM units. That is, a generation to be restored can be changed for each VM. The second modification is an example of a method of performing backup and restoration in VM units, and the invention does not depend on a backup method, and thus the invention can be applied to a case of performing backup in VM units by other methods.

Although the embodiments and some modifications have been described above, these embodiments are merely examples for describing the invention, and the scope of the invention is not limited to these embodiments and modifications. The invention can be implemented in various other forms. For example, both the first restore program 308 and the second restore program 309 may be provided in the backup server 300, and these programs 308 and 309 may be used differently depending on the case. For example, in a case where the cloud storage 500 is adopted as the verification storage 900, the second restore program 309 may be executed because it is expected that the cloud 2 has a calculation resource capable of sufficiently performing parallel scanning.

The above description can be summarized as follows. The following summary may include a supplementary description of the above description or a description of modifications.

A data recovery device (for example, the backup server 300 or the cloud backup server 700) including a memory (for example, the memory 273) and a processor (for example, the processor 274) that performs processing using a memory is constructed. The data recovery device is an example of a computer. The processor receives a restore instruction in which one or more generations are designated. For example, the first restore program 308 executed by the processor receives a restore instruction in which one generation is designated. The second restore program 309 executed by the processor receives a restore instruction in which a plurality of generations (or one generation) are designated.

The processor restores full backup data in a predetermined storage area (for example, the VVOL 217V or the VM storage area 120 (in particular, the base area 120V, for example)) into which data is written in response to a write request from a physical or virtual server (for example, the server 100 or the VM 110) in a restore destination area in a restore destination storage (for example, the verification storage 900 or the cloud storage 500), which is a storage having a restore destination area (for example, the restore destination VOL 17V) and a snapshot acquisition function (for example, the snapshot acquisition program 2222) of acquiring a snapshot in the restore destination area. For one or more generations from a generation corresponding to the full backup data (for example, a generation corresponding to 6/10) to the latest generation (for example, a generation corresponding to 6/13) among one or a plurality of designated generations, the processor overwrites incremental backup data corresponding to the generation in the restore destination area in order from the oldest generation. Every time full backup data or incremental backup data is written into the restore destination area, if a generation corresponding to the written data corresponds to at least one or a plurality of designated generations, the processor causes the snapshot acquisition function to acquire a snapshot (for example, the SSVOL 17S) in the restore destination area into which the full backup data or the incremental backup data is written for the generation. For at least one generation among one or a plurality of generations, the processor reproduces, in the restore destination area, data of the generation in the predetermined storage area by reflecting a snapshot corresponding to the generation in the restore destination area.

As a result, it is possible to reproduce the data for the at least one generation without restoring the backup data again, the time required for reproducing the data is shortened, and thus the data recovery time can be shortened. Specifically, for example, a backup destination storage device is generally a device physically or logically different from a backup source storage device so that normal data remains even when a backup source is infected, and the data recovery time can be shortened even when the backup source and the backup destination are different devices. For example, while the backup source storage device is an on-premise device, the backup destination storage device may be a device in a cloud, such as a software defined storage (SDS) implemented in the cloud.

The processor (for example, the first restore program 308) may receive, as the restore instruction, a restore instruction in which a generation N (for example, this N is a generation corresponding to 6/13) is designated. The processor may perform snapshot presence or absence determination as to whether a snapshot corresponding to the generation N designated by the restore instruction has been acquired in the restore destination storage. For this purpose, each time a snapshot is acquired, the processor may record, in the memory, information indicating that the acquired snapshot has been restored (for example, S205 or S208), and perform snapshot presence or absence determination by referring to the information recorded in the memory.

If the result of the snapshot presence or absence determination is false (for example, S202: No), the processor may reproduce, in the restore destination area, the data in the predetermined storage area of the generation N by overwriting the restore destination area with the incremental backup data corresponding to the generation among one or more generations from the generation corresponding to the full backup data restored in the restore destination area to the designated generation N in order from the oldest generation (for example, by a loop of S206 to S209). Every time full backup data or incremental backup data is written into the restore destination area, the processor may cause the snapshot acquisition function to acquire a snapshot in the restore destination area for a generation corresponding to the written data (for example, S204 or S207). The processor may perform damage presence or absence determination as to whether a damage is detected for the data of the generation N reproduced in the restore destination area as a scan result including checking whether the data is damaged data (for example, S306).

If the result of the damage presence or absence determination is true (for example, S306: No), the processor may receive a restore instruction in which N older than N designated in the immediately preceding restore instruction is designated as the generation N, and perform the snapshot presence or absence determination as to whether a snapshot corresponding to the generation N designated in the restore instruction has been acquired in the restore destination storage.

If the result of the snapshot presence or absence determination is true, the processor may reflect the snapshot corresponding to the generation N in the restore destination area (for example, S211) to reproduce, in the restore destination area, the data in the predetermined storage area of the generation N and perform the damage presence or absence determination.

Accordingly, data of the designated generation N can be reproduced at high speed, and thus the data recovery time until no damage (all data are normal) is detected can be shortened. The processor may determine the old N from the generations of the backed up data (for example, all generations specified by referring to catalogs and metadata of all backup data). Accordingly, data recovery can be efficiently performed.

The restore instruction may be a restore instruction in which the plurality of generations are designated. For one or more generations from a generation corresponding to the full backup data to the latest generation among a plurality of designated generations, the processor (for example, the second restore program 309) may overwrite the incremental backup data corresponding to the generation in the restore destination area in order from the oldest generation (for example, a loop of S206 to S209 in FIG. 14). Every time full backup data or incremental backup data is written into the restore destination area, if a generation corresponding to the written data corresponds to at least one or a plurality of designated generations, the processor may cause the snapshot acquisition function to acquire a snapshot in the restore destination area into which the full backup data or the incremental backup data is written for the generation (that is, the snapshot acquisition may be skipped if the generation corresponding to the written data does not correspond to any designated generation). For a plurality of generations, the processor may perform, in parallel, damage presence or absence determination as to whether a damage is detected as a scan result including checking whether data of restore destination areas and snapshots of the plurality of generations is damaged data. For at least one generation for which the damage presence or absence determination is false among the plurality of generations (for example, for the latest generation among the generations for which no damage is detected), the processor may reproduce, in the restore destination area, data of the generation in a predetermined storage area by reflecting a snapshot corresponding to the generation in the restore destination area.

Accordingly, scanning is performed at high speed, and data of a generation in which no damage is detected can be reproduced at high speed. The restore destination storage may have a scan function (for example, an existing scan function) for performing scanning. The parallel scanning may be performed in response to an instruction from the processor to the scan function. The restore destination storage may be a storage as a storage service in a cloud (for example, the cloud 2). Although a large number of computing resources may be required for parallel scanning, there is a high possibility that such computing resources are prepared in the case of cloud, and therefore, high-speed execution of parallel scanning is expected.

The full backup data and the incremental backup data may be stored in a backup destination storage (for example, the backup destination storage 400) as a storage different from the restore destination storage. The processor may read the full backup data from the backup destination storage and write the full backup data in the restore destination area, and similarly, may read the incremental backup data from the backup destination storage and overwrite the incremental backup data in the restore destination area.

The predetermined storage area may be a volume (for example, VVOL 217V), and the restore destination area may be a volume corresponding to the volume.

In addition, the predetermined storage area may be a storage area corresponding to a target virtual server among a plurality of virtual servers (for example, a plurality of VMs 110) in a plurality of storage areas (for example, a plurality of VM storage areas 120) corresponding to the plurality of virtual servers and managed by a virtualization platform (for example, the hypervisor 140). The restore destination area may be a storage area for the target virtual server.

The invention can be applied even when devices are not separated, such as the data recovery device, the backup source storage device, and the backup destination storage described above. For example, a storage system including at least one function of the data recovery device, the backup source storage device, and the backup destination storage may be constructed. The storage system may include a memory and a processor, and provide a volume to and from which data is input and output. The processor may back up data of a volume as snapshots of a plurality of generations. The processor may back up the snapshots as difference data, which is a difference from snapshots of other generations. When a restore instruction of data is received, the processor may restore a snapshot of one generation, apply difference data from the snapshot to the restored snapshot to restore a snapshot of another generation, repeat restoring a snapshot of another generation by applying another difference data to a snapshot restored by applying the difference data, and restore snapshots of a plurality of generations. The “backup” of the snapshot here may correspond to the “acquisition” in the embodiment. The “restore” of the snapshot referred to here may correspond to the “revert” referred to in the embodiment.

The processor restores a snapshot corresponding to a second generation to data of a first generation to reproduce data of the second generation different from the data of the first generation reproduced for the volume by restoring the snapshots of the plurality of generations. Either the first generation or the second generation may be a newer generation.

After reproducing the data of the volume using full backup data of the volume, the processor may reproduce data of a restore target generation for a volume and back up the snapshots of the plurality of generations by backing up the snapshot of the generation when overwriting the reproduced data of the volume with the data of the generation using differential backup data with other generations for each generation in order of the generation of the volume. The “order of generations” may be the order of older generations or the order of newer generations. For example, when data of a new generation is present in a first storage and data of an old generation is present in a second storage (a backup source storage), it is expected that the data recovery time can be shortened when data is reproduced from the data of the new generation.

For each generation, the “snapshot” is a volume at a specific time point, and may be all data in the volume logically. For each generation, the “snapshot data” may include base data, difference data, and incremental data. The “base data” may be the entire data of the volume. The “difference data” may be data as a difference from the base data (that is, difference data in a narrow sense). The “incremental data” may be data as a difference updated from the data of the previous generation snapshot, and may be included in difference data in a broad sense, for example. For example, the “difference data” in “the processor restores a snapshot of one generation, applies difference data from the snapshot to the restored snapshot to restore a snapshot of another generation” described above may be difference data in a broad sense, for example, incremental data. On the other hand, the “backup data” may be data as a unit in which a snapshot is created and stored in a storage having a primary VOL (for example, the above-described VVOL) and a plurality of pieces of snapshot data are collectively moved to a backup destination storage. The backup destination storage is, for example, an object storage or a file storage, and data may be read in backup data units. The “full backup data” includes base data, and may be capable of independently reproducing data of a volume. The “differential backup data” includes difference data, and the data may be reproduced together with the full backup data (for example, the differential backup data in a narrow sense). The “incremental backup data” includes incremental data, and the data may be reproduced together with the full backup data and other incremental data, and may be included in the differential backup data in a broad sense.

What is claimed is:

1. A storage system providing a volume to and from which data is input and output, the storage system comprising:
a memory; and
a processor, wherein
the processor is configured to
back up data of the volume as snapshots of a plurality of generations, and
back up the snapshots as difference data, which is a difference from snapshots of other generations, and
when a restore instruction of the data is received, the processor
restores a snapshot of one generation,
applies difference data from the snapshot to the restored snapshot to restore a snapshot of another generation, and
repeats restoring a snapshot of another generation by applying another difference data to a snapshot restored by applying the difference data, and restores snapshots of a plurality of generations.

2. The storage system according to claim 1, wherein
the processor restores a snapshot corresponding to a second generation to data of a first generation to reproduce data of the second generation different from the data of the first generation reproduced for the volume by restoring the snapshots of the plurality of generations.

3. The storage system according to claim 1, wherein
after reproducing the data of the volume using full backup data of the volume, the processor reproduces data of a restore target generation for the volume and backs up the snapshots of the plurality of generations by backing up the snapshot of the generation when overwriting the reproduced data of the volume with the data of the generation using differential backup data with other generations for each generation in order of the generation of the volume.

4. The storage system according to claim 3, wherein
the processor acquires the full backup data and the differential backup data from a backup source device.

5. The storage system according to claim 1, wherein
the processor performs damage presence or absence determination as to whether a damage is detected for data of a generation reproduced for the volume as a scan result including checking whether the data is damaged data, and
if a result of the damage presence or absence determination is true, in order to reproduce data of another generation different from the generation, the processor restores a snapshot corresponding to the other generation with respect to the data of the generation, and performs the damage presence or absence determination using the data of the other generation as the data of the reproduced generation.

6. The storage system according to claim 4, wherein
the processor determines the other generation from generations of the backed up data.

7. The storage system according to claim 1, wherein
the processor performs damage presence or absence determination as to whether a damage is detected as a scan result including checking whether data is damaged for at least one of the snapshots of the plurality of generations.

8. The storage system according to claim 7, wherein
the processor
performs the damage presence or absence determination in parallel for the snapshots of the plurality of generations, and
for at least one generation for which the damage presence or absence determination is false among the plurality of generations, restores a snapshot corresponding to the generation to reproduce data of the generation for the volume.

9. The storage system according to claim 8, wherein
at least a portion related to a scan function of performing the scan is included in a storage as a storage service in a cloud.

10. The storage system according to claim 1, wherein
the volume is a volume corresponding to a target virtual server among a plurality of virtual servers in a plurality of storage areas corresponding to the plurality of virtual servers and managed by a virtualization platform.

11. A storage control method performed by a computer, the storage control method comprising:
backing up, as snapshots of a plurality of generations, data of a volume to and from which data is input and output, and backing up the snapshots as difference data, which is a difference from snapshots of other generations; and
when a restore instruction of the data is received,
restoring a snapshot of one generation;
applying difference data from the snapshot to the restored snapshot to restore a snapshot of another generation; and
repeating restoring a snapshot of another generation by applying another difference data to a snapshot restored by applying the difference data, and restoring snapshots of a plurality of generations.
